(19) United States
(12) Patent Application Publication
(10) Pub. No.: US 2017/0334175 A1
(43) Pub. Date: Nov. 23, 2017

(54) THERMOFORMABLE MULTILAYER ELASTOMERIC BARRIER ARTICLES FOR MICROFLUIDIC DELIVERY SYSTEMS

(71) Applicant: Dow Global Technologies LLC, Midland, MI (US)

(72) Inventors: Cody W. Lawrence, Bellaire, TX (US); Jeffrey C. Munro, Bellaire, TX (US); Rajen M. Patel, Lake Jackson, TX (US); Kim L. Walton, Lake Jackson, TX (US)

(73) Assignee: Dow Global Technologies LLC, Midland, MI (US)

(21) Appl. No.: 15/520,268

(22) PCT Filed: Oct. 21, 2015
(86) PCT No.: PCT/US2015/056561

§ 371 Date: Apr. 19, 2017

Related U.S. Application Data
(60) Provisional application No. 62/073,400, filed on Oct. 31, 2014.

(51) Int. Cl. B32B 27/08; B32B 27/28; B32B 7/12; B32B 27/30; B32B 27/34

(52) U.S. Cl. CPC B32B 27/08; B32B 27/304; B32B 27/34; B32B 27/306; B32B 7/12; B32B 27/302; B32B 27/285; B32B 2307/7244

(57) ABSTRACT

Embodiments of multilayer film structures comprise at least one elastic layer comprising thermoplastic elastomer, at least one barrier layer comprising ethylene vinyl alcohol, polyamides, polyvinylidene chloride, or combinations thereof, and at least Cone tie layer disposed between and adhering the at least one elastic layer to the at least one barrier layer, wherein the at least one tie layer comprises thermoplastic elastomer and functionalized olefin-based polymer.

### CROSS-REFERENCE TO RELATED APPLICATIONS

This application claims priority to U.S. Provisional Patent Application No. 62/073,400, filed Oct. 31, 2014, entitled “Thermoformable Multilayer Elastomeric Barrier Articles For Microfluidic Delivery Systems”, the contents of which are hereby incorporated by reference in their entirety.

### TECHNICAL FIELD

Embodiments of the present disclosure are generally related to multilayer film structures, and are specifically related to thermoformable multilayer barrier structures suitable for microfluidic delivery systems.

### BACKGROUND

Barrier articles are utilized in various devices, for example, microfluidic devices and medical devices. These microfluidic delivery systems include drug delivery devices, such as infusion pumps, for example, insulin pumps. Barrier articles may be used as oxygen barrier membranes for insulin pumps. For additional details regarding infusion pumps, US Publication US 20140054883 A1 is incorporated by reference herein in its entirety.

Well-known barrier articles alone are too stiff and lack the elasticity and compliance to perform as sealing and pumping membranes in such devices. Elastomers, such as bromobutyl rubber, Santoprene™ thermoplastic vulcanizate (TPV), Viton™ fluoropolymer, SEBS-compounds, and silicones have the necessary elasticity and compliance, but have undesirably high water and air permeability.

As a result, there may be a continual need for barrier articles which provide elasticity and compliance, while limiting oxygen transport.

### SUMMARY

According to one embodiment, a multilayer film structure is provided. The multilayer film structure comprises at least one elastic layer comprising thermoplastic elastomer, at least one barrier layer comprising ethylene vinyl alcohol, polyamides, polyvinylidene chloride, or combinations thereof, and at least one tie layer disposed between and adhering the at least one elastic layer to the at least one barrier layer, wherein the at least one tie layer comprises thermoplastic elastomer and functionalized olefin-based polymer. Additional embodiments of the tie layer may include may include functionalized olefin-based polymer and optionally at least one of thermoplastic elastomer, polyethylene, or polypropylene.

According to another embodiment, a method of making a membrane is provided. The method comprises coextruding at least one elastic layer, the barrier layer, and the at least one tie layer, wherein the at least one elastic layer comprises thermoplastic elastomer, the at least one barrier layer comprises ethylene vinyl alcohol, polyamides, polyvinylidene chloride, or combinations thereof, and the at least one tie layer comprises thermoplastic elastomer and functionalized olefin-based polymer; producing a coextruded multilayer film structure by bonding the layers such that the tie layer is disposed between the at least one elastic layer and the at least one barrier layer; and thermoforming the multilayer film structure into a membrane.

### BRIEF DESCRIPTION OF THE DRAWINGS

The following detailed description of specific embodiments of the present disclosure can be best understood when read in conjunction with the drawings enclosed herewith.

FIG. 1 is a schematic illustration of a 5 layer barrier article in accordance with one or more embodiments of the present disclosure.

The embodiments set forth in the drawings are illustrative in nature and not intended to be limiting of the invention defined by the claims. Moreover, individual features of the drawings will be more fully apparent and understood in view of the detailed description.

### DETAILED DESCRIPTION

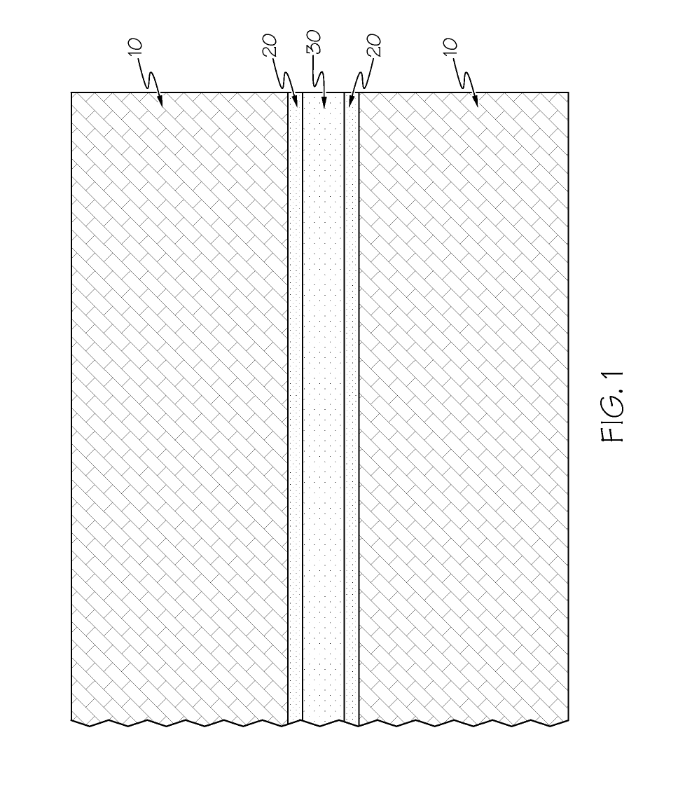

Referring to FIG. 1, the multilayer film structure 1 (or barrier article) comprises at least one elastic layer 10, at least one barrier layer 30, and at least one tie layer 20. Specifically as shown in the embodiment of FIG. 1, the multilayer film structure 1 may comprise two elastic layers 10, one barrier layer 30, and at two tie layers 20, wherein the tie layers 20 are disposed between and adhering the elastic layers 10 to the one barrier layer 30. While the depicted multilayer film structure 1 is a 5 layer structure, other layer configurations are contemplated herein, for example and not by way of limitation, a 3 layer, a 5 layer, or a 7 layer structure.

The elastic layer 10, which is the outermost skin layer in some embodiments, comprises thermoplastic elastomer. The thermoplastic elastomer may comprise thermoplastic vulcanizates, thermoplastic polyolefin elastomers, thermoplastic polyurethane elastomers, polyether block amide thermoplastic elastomers, polyester block amide thermoplastic elastomers, styrenic block copolymers, ethylene-vinyl-acetate, f-PVC, and combinations thereof.

In one embodiment, the thermoplastic elastomer comprises thermoplastic vulcanizate. One suitable commercial embodiment of thermoplastic vulcanizate is the Santoprene ® 8281-45MED manufactured by ExxonMobil.

The thermoplastic polyolefin elastomers may be chosen from ethylene-α-olefin copolymers, olefin block copolymers, propylene-ethylene copolymers, polyolefin terpolymers, and combinations thereof. Suitable polyolefin elastomers may include ENGAGE™ Polyolefin Elastomers, AFFINITY™ Polyolefin Plastomers and Elastomers, VERSIFY™ Plastomers and Elastomers and INFUSE™ Olefin Block Copolymers produced by The Dow Chemical Company (Midland, Mich.).

The styrenic block-copolymers may include elastomers chosen from styrene-ethylene/butylene-styrene (SEBS) block copolymers, styrene-ethylene/propylene-styrene (SEPS) block copolymers, styrene -butadiene-styrene (SBS) block copolymers, styrene-isoprene-styrene (SIS) block copolymers, and combinations thereof. Suitable styrenic block-copolymers are the Kraton® D and Kraton® G line of polymers produced by Kraton Performance Polymers Inc.

Similarly, various polyether block amide thermoplastic elastomers are also contemplated, for example, the Pebax® product line from Arkema. Further, various polyester block thermoplastic elastomers are also contemplated, for example, the Hytrel® product line from Dupont.

Optionally, the elastic layer 10 may include additional components in addition to the thermoplastic elastomer. Alternatively, it is contemplated to blend different thermoplastic elastomers.

Like the elastic layer 10, the tie layer 20 may also comprise thermoplastic elastomer, yet the tie layer 20 further includes a functionalized olefin-based polymer. The tie layer 20 may include the same thermoplastic elastomer as the elastic layer 10, or alternatively, it may include different thermoplastic elastomers. Without being bound by theory, the adhesion between the elastic layer 10 and tie layer 20 is improved if the thermoplastic elastomer composition is the same in each respective layer. While the above compositions primarily discuss the inclusion of thermoplastic elastomer in the tie layer, it is contemplated to also include polyethylene and/or polypropylene as an alternative to the thermoplastic elastomer. Moreover, the polyethylene and/or polypropylene may also be used in combination with the thermoplastic elastomer. Furthermore, it is also contemplated to have a tie layer comprising functionalized olefin-based polymer, wherein thermoplastic elastomer, polyethylene, polypropylene, or combinations thereof are merely optional.

Various compositions suitable for achieving adhesion to the barrier layer 30 are contemplated for the functionalized olefin-based polymer. The functionalized olefin-based polymer may comprise various olefins, for example, C2-C10, or C2-C6 olefins. In specific embodiments, the olefin of the functionalized olefin-based polymer may be ethylene or propylene, with most embodiments being functionalized ethylene-based polymers. The functionalized ethylene-based polymer is selected from the group consisting of a functionalized ethylene homopolymer, a functionalized ethylene/α-olefin copolymer, and combinations thereof.

For the functionalized ethylene/α-olefin copolymer, the α-olefin may include C3-C20 α-olefins, or in further embodiments, C3-C10 α-olefins, or C3-C8 α-olefins. For example and not by way of limitation, the α-olefins may include propylene, 1-butene, 1-pentene, 1-hexene, 1-heptene and 1-octene, and combinations thereof.

The functional moieties of the functionalized ethylene-based polymer may comprise carboxyl groups, anhydride groups or combinations thereof. In one or more embodiments, the functionalized ethylene-based polymer units may be derived from ethylene and maleic anhydride (MAH) and/or maleic acid. In exemplary embodiments, the functionalized ethylene-based polymer may be a maleic anhydride (MAH)-grafted ethylene-based polymer. As used herein, a “MAH-grafted ethylene-based polymer” comprises grafted groups derived from maleic anhydride. The MAH-grafted ethylene-based polymer may have an MAH-graft level from 0.05 to 1.20 weight percent, based on the weight of the ethylene-based polymer. In a further embodiment, the MAH-grafted ethylene-based polymer may have an MAH-graft level from 0.07 to 1.00 weight percent, or from about 0.10 to 1.00 weight percent, based on the weight of the functionalized ethylene-based polymer.

One example of a MAH-grafted ethylene-based polymer is maleic anhydride grafted (MAH) ethylene-octene copolymer. The AMPLIFY™1052H product, which is produced by The Dow Chemical Company (Midland, Mich.), is a suitable maleic anhydride grafted (MAH) ethylene-octene copolymer product.

The functionalized olefin-based polymer may have a density from about 0.86 to about 0.94 g/cc, or from about 0.86 to about 0.93 g/cc, or further from about 0.86 to about 0.90 g/cc in accordance with ASTM D 792. Additionally, the functionalized olefin-based polymer may have a melt index (I2) from about 0.5 to about 10 g/10 min, or further from about 0.7 to about 5 g/10 min when measured in accordance with ASTM D1238 (Conditions 190° C./2.16 kg).

While various compositions are contemplated for the tie layer(s) 20, the tie layer 20 may, in many embodiments, generally include more thermoplastic elastomer than functionalized-olefin based polymer. In one or more embodiments, the tie layer 20 may comprise about 60% to about 95% by wt. thermoplastic elastomer, or about 70% to about 90% by wt., or about 75% to about 85% by wt. Additionally, the tie layer 20 may comprise about 5% to about 40% by wt. functionalized olefin-based polymer, or about 10% to about 30% by wt., or about 15% to about 25% by wt.

As stated above, it is also contemplated that in some embodiments that the tie layer may include functionalized olefin-based polymer with one or more of polyethylene, polypropylene, thermoplastic elastomer, or combinations thereof being optional. In such embodiments, it is contemplated that the tie layer may include 5% to about 95% by wt polyethylene or polypropylene and about 5% to about 100% by wt functionalized olefin-based polymer.

The barrier layer 30 may comprise at least one of ethylene vinyl alcohol, polyamides, polyvinylidene chloride, or combinations thereof. In specific embodiments, the barrier layer comprises polyamide. For example and not by way of limitation, the polyamide may include medium viscosity nylon, high viscosity nylon, or combinations thereof. In one embodiment, the polyamide may be high viscosity polyamide 6,6-6 grade. UBE Nylon 5033B is a commercially available polyamide 6,6-6 grade product from UBE Engineering Plastics, S.A. (Dusseldorf, Germany). UBE NYLON 5033 B is a basic, high viscosity Polyamide 6/6-6 grade without any additional modification, and thus is suitable for a wide range of film and extrusion applications. Alternative grades of polyamide 6/6-6 could also be used, such as Ultramid C33 available from the BASF Corporation.

Depending on the application, various thicknesses and sizes for the multilayer film structure are contemplated. For example, the multilayer film structure may have a thickness of about 5 to about 40 mils, or about 5 to about 20 mils. The elastic layer may have a layer thickness of about 50 to about 90% of a total thickness of the multilayer film structure, or from about 65 to about 85% of a total thickness of the multilayer film structure, or from about 75 to about 80% of a total thickness of the multilayer film structure. Whether one or multiple barrier layers are used, the barrier layer(s) may include a thickness of 2 mils to 36 mils, or 5 to 25 mils within the overall thickness of the multilayer film structure.

The tie layer 20 thickness is dependent on many factors, for example, the industrial application, the compositions of the tie layer or the other layers, etc. In one or more embodiments, the at least one tie layer may include a layer thickness equal to about 4 to about 45% of a total thickness of the multilayer film structure, or about 5 to about 30%, or about 5 to about 20% of a total thickness of the multilayer film structure. Whether one or multiple tie layers are used, the tie layer(s) may include a thickness of 0.05 mils to 18 mils, or 1 to 10 mils within the overall thickness of the multilayer film structure.

The barrier layer 30 may have a layer thickness equal to about 1 to about 30% of a total thickness of the multilayer film structure, or about 3 to about 10% of a total thickness of the multilayer film structure. The barrier may comprise a thickness of about 0.05 mils to about 12 mils, or about 0.1 mils to about 4 mils.

As stated above, the multilayer film structure provides oxygen barrier properties while maintaining mechanical strength and thermoformability. As an oxygen barrier, the multilayer film structure may have a maximum oxygen transmission rate of about 100 cc/100 sq. in/day, or a maximum of about 50 cc/100 sq. in/day, or a maximum of about 20 cc/100 sq. in/day, or a maximum of about 10 cc/100 sq. in/day when measured according to ASTM Method D3985. From a flexibility standpoint, the multilayer film structure has a secant modulus of about 3,000 to about 10,000 psi, or about 5,000 to 8,000 psi when measured according to ASTM Method D882. Without being bound by theory, it is believed that this combination of properties enables the multilayer film structure to retain its flexibility over multiple days and flex cycles while still retaining its oxygen barrier properties.

As stated above, these multilayer structures may be fabricated into oxygen barrier membranes. In one embodiment, multilayer membrane may be produced by extruding at least one elastic layer, the barrier layer, and the at least one tie layer, and producing the multilayer film structure by bonding the layers such that the tie layer is disposed between the at least one elastic layer and the at least one barrier layer. At which point, the multilayer film structure may be thermoformed into a membrane. The extrusion may be performed via cast coextrusion or blown film coextrusion. For additional details regarding thermoforming, U.S. Pat. No. 7,935,301 is incorporated by reference herein in its entirety.

### EXAMPLES

Table 1 below lists Comparative Examples 1 and 2, which include 100% Santoprene, and Examples 1 and 2, which are two exemplary embodiments of the present multilayer structure.

TABLE 1

| | | Layer Ratio | | |
|---|---|---|---|---|
| | Layer | (% of total | | Thickness |
| Sample | Structure | thickness) | Composition | (mils) |
| Comparative | 1 Layer (A) | 100 | Santoprene TPV 8281-45MED | 10 mils |
| Example 1 | | | | |
| Comparative | 1 Layer (A) | 100 | Santoprene TPV 8281-45MED | 15 mils |
| Example 2 | | | | |
| Example 1 | 5 Layer | 39.5/8/5/8/39.5 | Composition A - 100% | 10 mils |
| | (A/B/C/B/A) | | Santoprene TPV 8281-45MED | |
| | | | Composition B - 80% | |
| | | | Santoprene TPV 8281-45MED + | |
| | | | 20% AMPLIFY ™ 1052H | |
| | | | Composition C- 100% | |
| | | | Polyamide 6,6-6: UBE 5033B | |
| Example 2 | 5 Layer | 39.5/8/5/8/39.5 | Composition A - 100% | 15 mils |
| | (A/B/C/B/A) | | Santoprene TPV 8281-45MED | |
| | | | Composition B - 80% | |
| | | | Santoprene TPV 8281-45MED + | |
| | | | 20% AMPLIFY ™ 1052H | |
| | | | Composition C- 100% | |
| | | | Polyamide 6,6-6: UBE 5033B | |

All films were fabricated on a combination, three and five layer coextrusion line. The system consisted of four extruders: two 25 mm extruders for the outer elastic layers, one 30 mm extruder for the two tie layers, and one 30 mm extruder for the core layer. During the coextrusion process, the individual extruded layers are combined and coextruded through a die. The lines for all examples operated at a line speed of 3 m/min.

Although Comparative Examples 1 and 2 were comprised entirely of Santoprene, two 25 mm extruders were used for the Santoprene elastic layers and a third 30 mm extruder was used for the Santoprene core layer, and the fourth 30 mm extruder was unused. The temperature in all three extruders ranged from about 170 to 200° C. from inlet to outlet of the extruder, and the die maintained a temperature of about 215° C. Additional details on the operating temperatures used in the fabrication of Comparative Examples 1 and 2 are provided in Table 2 below.

TABLE 2
Operating Temperatures for Comparative Examples 1 and 2

| | | Temp. | | Temp. | | Temp. | | Temp. | | Temp. |
|---|---|---|---|---|---|---|---|---|---|---|
| Extruder | Zone | (° C.) | Zone | (° C.) | Zone | (° C.) | Zone | (° C.) | Zone | (° C.) |
| 25 mm | 1 | 170 | 2 | 180 | 3 | 190 | 4 | 200 | Adaptor | 200 |
| Extruder 1 | | | | | | | | | Zone | |
| (Santoprene | | | | | | | | | | |
| Elastic | | | | | | | | | | |
| Layer) | | | | | | | | | | |
| 25 mm | 1 | 170 | 2 | 180 | 3 | 190 | 4 | 200 | Adaptor | 200 |
| Extruder 2 | | | | | | | | | Zone | |
| (Santoprene | | | | | | | | | | |
| Elastic | | | | | | | | | | |
| Layer) | | | | | | | | | | |
| 30 mm | 1 | 170 | 2 | 180 | 3 | 190 | 4 | 200 | Adaptor | 200 |
| Core Layer | | | | | | | | | Zone | |
| Extruder | | | | | | | | | | |
| (Santoprene | | | | | | | | | | |
| Core Layer) | | | | | | | | | | |
| Die | Coex. | 215 | Coex. | 215 | Die | 215 | Die | 215 | Die Zone 3 | 215 |
| | Zone 1 | | Zone 2 | | Zone 1 | | Zone 2 | | | |

The extrusion parameters utilized in the production of Comparative Examples 1 and 2 is provided in Table 3 below.

TABLE 3
Extrusion Parameters for Comparative Examples 1 and 2

| | | | | |
|---|---|---|---|---|
| | Screw | Motor | Melt | Melt |
| | Speed | Current | Temperature | Pressure |
| Extruder/Die | (rpm) | (A) | (° C.) | (bar) |

Comparative Example 1

| | | | | |
|---|---|---|---|---|
| 25 mm Extruder | 102 | 1.5 | 198 | 65 |
| 1 (Santoprene | | | | |
| Elastic Layer) | | | | |
| 25 mm Extruder | 32 | 2 | 187 | 86 |
| 2 (Santoprene | | | | |
| Elastic Layer) | | | | |
| 30 mm | 102 | 1.4 | 193 | 68 |
| Core Layer | | | | |
| Extruder | | | | |
| (Santoprene Core | | | | |
| Layer) | | | | |

Comparative Example 2

| | | | | |
|---|---|---|---|---|
| 25 mm Extruder | 150 | 1.7 | 202 | 73 |
| 1 (Santoprene | | | | |
| Elastic Layer) | | | | |
| 25 mm Extruder | 60 | 2.4 | 191 | 100 |
| 2 (Santoprene | | | | |
| Elastic Layer) | | | | |
| 30 mm | 150 | 1.6 | 195 | 75 |
| Core Layer | | | | |
| Extruder | | | | |
| (Santoprene Core | | | | |
| Layer) | | | | |

Additionally, Comparative Example 1 was outputted at an output rate of 12 Kg/hr and Comparative Example 2 was outputted at an output rate of 17 Kg/hr.

Examples 1 and 2 utilized all four extruders. Like the Comparative Examples 1 and 2, the two 25 mm extruders used to produce the elastic layers had a temperature ranging from 170 to 200° C. from inlet to outlet of the extruder. However, the 30 mm barrier layer extruder operated at temperatures ranging from 235 to 250° C., because the polyamide composition has a higher melting temperature. Similarly, the 30 mm tie layer extruder also used higher operating temperatures, because the Amplify 1052H results in a higher melt temperature for the tie layers, specifically a range from 170 to 224° C. The die temperature ranged from about 230-215° C. from inlet to outlet. Additional details on the operating temperatures used in the fabrication of Examples 1 and 2 are provided in Table 4 below.

TABLE 4
Operating Temperatures for Examples 1 and 2

| | | Temp. | | Temp. | | Temp. | | Temp. | | Temp. |
|---|---|---|---|---|---|---|---|---|---|---|
| Extruder/Die | Zone | (° C.) | Zone | (° C.) | Zone | (° C.) | Zone | (° C.) | Zone | (° C.) |
| 25 mm Extruder | 1 | 170 | 2 | 180 | 3 | 190 | 4 | 200 | Adaptor | 200 |
| 1 (Santoprene | | | | | | | | | Zone | |
| Elastic Layer) | | | | | | | | | | |
| 25 mm Extruder | 1 | 170 | 2 | 180 | 3 | 190 | 4 | 200 | Adaptor | 200 |
| 2 (Santoprene | | | | | | | | | Zone | |
| Elastic Layer) | | | | | | | | | | |
| 30 mm | 1 | 235 | 2 | 240 | 3 | 245 | 4 | 250 | Adaptor | 250 |
| Barrier Layer | | | | | | | | | Zone | |
| Extruder | | | | | | | | | | |
| (Polyamide 6,6- | | | | | | | | | | |
| 6) | | | | | | | | | | |
| 30 mm | 1 | 170 | 2 | 215 | 3 | 220 | 4 | 224 | Adaptor | 224 |
| 2 Tie Layer | | | | | | | | | Zone | |
| Extruder | | | | | | | | | | |
| (Santoprene + | | | | | | | | | | |
| AMPLIFY) | | | | | | | | | | |
| Die | Coex. | 215 | Coex. | 215 | Die | 215 | Die | 215 | Die Zone 3 | 215 |
| | Zone 1 | | Zone 2 | | Zone 1 | | Zone 2 | | | |

The extrusion parameters utilized in the production of Examples 1 and 2 is provided in Table 5 below.

TABLE 5
Extrusion Parameters for Examples 1 and 2

| | | | | |
|---|---|---|---|---|
| | Screw | Motor | Melt | Melt |
| | Speed | Current | Temperature | Pressure |
| Extruder/Die | (rpm) | (A) | (° C.) | (bar) |

Example 1

| | | | | |
|---|---|---|---|---|
| 25 mm Extruder | 110 | 1.5 | 201 | 63 |
| 1 (Santoprene | | | | |
| Elastic Layer) | | | | |
| 25 mm Extruder | 110 | 1.5 | 195 | 70 |
| 2 (Santoprene | | | | |
| Elastic Layer) | | | | |
| 30 mm | 7 | 1.2 | 243 | 62 |
| Barrier Layer | | | | |
| Extruder | | | | |
| (Polyamide 6,6-6) | | | | |
| 30 mm | 20 | 2.2 | 213 | 92 |
| 2 Tie Layer | | | | |
| Extruder | | | | |
| (Santoprene + | | | | |
| AMPLIFY) | | | | |

Example 2

| | | | | |
|---|---|---|---|---|
| 25 mm Extruder | 155 | 1.7 | 201 | 71 |
| 1 (Santoprene | | | | |
| Elastic Layer) | | | | |
| 25 mm Extruder | 155 | 1.6 | 196 | 75 |
| 2 (Santoprene | | | | |
| Elastic Layer) | | | | |
| 30 mm | 9 | 1.2 | 243 | 68 |
| Barrier Layer | | | | |
| Extruder | | | | |
| (Polyamide 6,6-6) | | | | |
| 30 mm | 27 | 2.7 | 213 | 99 |
| 2 Tie Layer | | | | |
| Extruder | | | | |
| (Santoprene + | | | | |
| AMPLIFY) | | | | |

Additionally, Example 1 was outputted at an output rate of 13.5 Kg/hr and Example 2 was outputted at an output rate of 17 Kg/hr.

After fabrication, the oxygen transmission rate (OTR) and water vapor transmission rate (WVTR) was tested on the films and the results are provided in Table 6 below. ASTM Method D3985 was used to test OTR, and the results were obtained using a Mocon OxTran® 2/21. ASTM Method D1249 was used to test WVTR, and the results were obtained using a Mocon PermaTran-W® 700.

TABLE 6

| | | | Water Vapor |
|---|---|---|---|
| | | | Transmission |
| | | Oxygen | Rate |
| | | Transmission | Transmission |
| | Thickness | Rate (cc/(100 | Rate (cc/(100 |
| | (mils) | sq. in-day-atm)) | sq. in-day-atm)) |
| Comparative | 10.77 | 545.07 | 0.835 |
| Example 1 | | | |
| Comparative | 15.21 | 383.54 | 0.61 |
| Example 2 | | | |
| Example 1 | 10.60 | 7.41 | 0.775 |
| Example 2 | 15.57 | 6.70 | 0.495 |

As shown in Table 6, Examples 1 and 2 reduces the OTR by multiple magnitudes in comparison to the Comparative Examples 1 and 2. While the WVTR reduction is not as substantial as the OTR reduction, Examples 1 and 2 also demonstrate a reduction in WVTR as compared to Comparative Examples 1 and 2

Table 7 below shows the difference in Secant Modulus between monolayer Comparative Examples 1 and 2 and 5 layer Examples 1 and 2 when the films are stretched in the machine direction or cross direction. Secant Modulus was measured using ASTM method D882. While the tensile secant modulus is higher for Examples 1 and 2, these films have sufficient flexibility for elastic barrier article applications.

| | Avg. Secant Modulus - | Avg. Secant Modulus - |
|---|---|---|
| | Cross Direction (psi) | Machine Direction (psi) |
| Comparative | 724 | 722 |
| Example 1 | | |
| Comparative | 726 | 819 |
| Example 2 | | |
| Example 1 | 7388 | 7353 |
| Example 2 | 6758 | 6614 |

It is further noted that terms like “preferably,” “generally,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present disclosure.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

1. A multilayer film structure comprising:
at least one elastic layer comprising thermoplastic elastomer;
at least one barrier layer comprising ethylene vinyl alcohol, polyamides, polyvinylidene chloride, or combinations thereof; and
at least one tie layer disposed between and adhering the at least one elastic layer to the at least one barrier layer, wherein the at least one tie layer comprises thermoplastic elastomer and functionalized olefin-based polymer, wherein the functionalized olefin-based polymer is selected from the group consisting of a functionalized ethylene homopolymer, a functionalized ethylene/α-olefin copolymer, and combinations thereof.

2. The multilayer film structure of claim 1 wherein the multilayer film structure includes at least two tie layers, and at least two elastic layers.

3. The multilayer film structure of claim 1 wherein the thermoplastic elastomer of the at least one elastic layer, the at least one tie layer, or both, is selected from the group consisting of thermoplastic vulcanizates, thermoplastic polyolefin elastomers, thermoplastic polyurethane elastomers, ethylene-vinyl-acetate elastomers, polyether block amide thermoplastic elastomers, polyester block amide thermoplastic elastomers, styrenic block copolymers, and combinations thereof.

4. The multilayer film structure of claim 1, wherein the at least one elastic layer has a layer thickness equal to about 10 to about 90% of a total thickness of the multilayer film structure, the at least one tie layer has a layer thickness equal to about 4 to about 45% of a total thickness of the multilayer film structure, and the at least one barrier layer has a layer thickness equal to about 1 to about 30% of a total thickness of the multilayer film structure.

5. The multilayer film structure of claim 1, wherein the at least tie layer comprises about 60% to about 95% by wt. thermoplastic elastomer, and about 5% to about 40% by wt. of the functionalized olefin-based polymer.

6. (canceled)

7. The multilayer film structure of claim 1 wherein the functionalized ethylene/α-olefin copolymer is maleic anhydride grafted ethylene-octene copolymer.

8. The multilayer film structure of claim of 1, wherein the at least one barrier layer comprises polyamide.

9. The multilayer film structure of claim 1, wherein the multilayer film structure has a maximum oxygen transmission rate of 100 cc/(100 sq. in-day-atm) when measured according to ASTM Method D3985.

10. The multilayer film structure of claim 1, wherein the multilayer film structure has a secant modulus of 3,000 to 12,000 psi when measured according to ASTM Method D882.

11. A membrane comprising the multilayer film structure of claim 1.

12. A method of making a membrane comprising:
coextruding at least one elastic layer, the barrier layer, and the at least one tie layer, wherein the at least one elastic layer comprises thermoplastic elastomer, the at least one barrier layer comprises ethylene vinyl alcohol, polyamides, polyvinylidene chloride, or combinations thereof, and the at least one tie layer comprises functionalized olefin-based polymer and thermoplastic elastomer, wherein the functionalized olefin-based polymer is selected from the group consisting of a functionalized ethylene homopolymer, a functionalized ethylene/α-olefin copolymer, and combinations thereof;
producing a coextruded multilayer film structure by bonding the layers such that the tie layer is disposed between the at least one elastic layer and the at least one barrier layer; and
thermoforming the coextruded multilayer film structure into a membrane.

13. The method of claim 12 wherein the coextruding is performed via cast coextrusion or blown film coextrusion.

14. (canceled)

15. (canceled)

16. The method of claim 12, wherein the functionalized ethylene/α-olefin copolymer is maleic anhydride-grafted ethylene/α-olefin copolymer.
